(19) United States
(12) Patent Application Publication
(10) Pub. No.: US 2026/0302056 A1
(43) Pub. Date: Oct. 1, 2026

(54) MEDIUM-VOLTAGE ISOLATION TRANSFORMER

(71) Applicant: Delta Electronics, Inc., Taipei (TW)

(72) Inventors: Anup Anurag -, Morrisville, NC (US); Ruxi WANG, Morrisville, NC (US); Peter Mantovanelli BARBOSA, Taoyuan City (TW); Boxue HU, Morrisville, NC (US)

(73) Assignee: Delta Electronics, Inc., Taipei (TW)

(21) Appl. No.: 19/577,542

(22) Filed: Mar. 25, 2026

Related U.S. Application Data
(60) Provisional application No. 63/777,122, filed on Mar. 25, 2025.

(51) Int. Cl. H01F 27/32; H01F 27/24

(52) U.S. Cl. CPC H01F 27/327; H01F 27/24

(57) ABSTRACT

This disclosure relates to a medium-voltage isolation transformer. The medium-voltage isolation transformer includes a magnetic core, a low-voltage winding wound around the magnetic core, wherein the low-voltage winding is exposed in air; and a medium-voltage winding assembly including: a medium-voltage winding wound around the magnetic core; and a potting material body, wherein the medium-voltage winding is embedded inside the potting material body, the potting material body is filled with potting material, and the medium-voltage winding is configured by a litz wire whose external surface is covered by a first semi-conductive layer.

### RELATED APPLICATION

This application claims the benefit of priority under 35 U.S.C. § 119(e) of U.S. Provisional Patent Application No. 63/777,122, filed on Mar. 25, 2025, the contents of which are all incorporated by reference herein in their entirety.

### FIELD

The disclosure relates to a power transformer. More particularly, the present disclosure relates to a medium-voltage isolation transformer providing with insulation between individual windings, the winding and cores for medium-voltage applications.

### BACKGROUND

With the use of wide bandgap semiconductors, like Silicon Carbide (SiC) and Gallium Nitride (GaN) based power devices, new application areas like data centers and EV charging infrastructure have opened up. The use of wide bandgap devices makes it possible to achieve higher voltage blocking and operate at high switching frequencies without sacrificing efficiency. In applications such as data center power, medium-voltage distribution is preferred to low-voltage distribution, due to its reduced copper usage, lower losses and potentially smaller footprint. In medium-voltage applications (larger than 4.16 kV), conventionally a line frequency transformer is used to step-down the medium voltage alternating current (MVAC) voltage to low voltage alternating current (LVAC) voltage, which can be then converted into low voltage direct current (LVDC) voltage (if required) to be fed to the load. These conventional transformers operate at line frequency which inherently leads to a bulky design. To reduce the footprint of conventional transformers, and to add smart functionalities to this transformation stage, a solid-state transformer (SST) technology has been developed [1]. The use of semiconductors adds a degree of freedom to the fact that the line frequency AC stage can be converted into medium/high frequency AC, which can then be used to step-up or step-down the voltage, after which it can be converted into either DC or line frequency AC depending on the application.

Further, Solid-state transformers become popular in application areas such as data centers, solar farms, and electric vehicle charging stations. A solid-state transformer can convert medium-voltage ac grid to low-voltage ac or dc according to its load requirements. Isolation transformers are critical components in a solid-state transformer. FIG. 1 shows an example of isolation transformers 10P in a solid-state transformer 1P, wherein the isolated primary and secondary windings of the transformer need to sustain medium-voltage stress. The use of medium/high frequency AC significantly reduces the size of the transformer, which leads to a reduction in the footprint of the entire system. The reduction in size is due to the much lower volt-seconds applied to the transformer on account of the high frequency, which enables lower turns and/or lower area of cross-section.

However, for medium-voltage applications, the size of the transformer is not inversely proportional to the frequency since the medium-voltage insulation between the individual windings, and the windings and the core can take up significant volume, especially when the blocking voltage capacity is high, and the size of the transformer is smaller.

It should also be noted that with the use of these medium/high frequency transformers, the core material as well as the winding structure needs to be modified. Compared to conventional line frequency transformers which typically use silicon steel as the core material, and solid copper as the winding structure, medium/high frequency transformers use high frequency materials such as ferrite or nanocrystalline to realize the core structure, and litz wire for the winding structure. This ensures that the transformer is small and provides high efficiency.

There are several considerations that need to be followed to design, operate and manufacture a medium-voltage transformer. For long term reliable operation, the transformer should be free from partial discharge (PD) during its operation in the system. Repeated partial discharge causes insulation degradation and corona discharge which leads to failure of the medium-voltage insulation. This is a critical requirement which inhibits the basic functionality of the transformer in a long-term scenario. For lower losses and costs, the transformer should offer high efficiency and high-power density. Since the medium frequency transformer competes directly against the line frequency transformers, efficiency is a key performance indicator. A smaller size of the transformer makes the system dense and lowers its footprint which saves space and cost in critical applications. The transformer should be easy to manufacture and offer a certain degree of repeatability for mass production. Ideally, it should be maintenance free and not require replacement or testing of certain parts of the transformer from time to time.

Based on these considerations, a variety of medium-voltage transformers are proposed in the literature. In a most conventional sense, a transformer can be made by having two winding structures 10Q and 20Q on either side of a core 30Q, as shown in FIGS. 2A and 2B. The challenge with the medium-voltage insulation comes from the fact that enough spacing is required between the cores 30Q and the winding structures 10Q and 20Q, as well as between the winding structures 10Q and 20Q to withstand the medium voltage. Since air ideally breaks down at 3 kV/mm, the limits to how much the spacing can be provided are limited. Especially when higher voltage blocking capacity is necessary, a sub-optimal design is obtained. This design can be improved by submersing the whole structure in an insulating oil. Oil has a higher breakdown voltage which helps reduce the distance between the winding and the cores, and also between the windings. Furthermore, oil helps in providing a thermal path and helps in cooling the cores as well as the winding structure. However, oil is generally not environmentally friendly and is difficult to manage [2]. They require maintenance from time to time, which does not make it the first choice of use. In some designs, the oil can be replaced with an encapsulating material. In these structures, litz wires are used for higher efficiency and litz wires consist of multiple small strands which are electrically insulating from one another. During the potting process, it is relatively difficult to extract all the air bubbles from the gaps between the individual strands. Therefore, the combination of litz wire and a potting process is not an amenable one.

In [3], a PCB winding structure is used to achieve the required voltage insulation, as seen in FIG. 3. In this solution, a PCB winding 10R is used on the primary side (medium voltage) and litz winding 20R is used as the secondary winding structure (low voltage). The medium-voltage insulation is provided by the PCB structure. A semi-conductive paint is applied to the PCB structure and is electrically connected to the lower voltage potential. This ensures that the entire voltage is applied between the medium-voltage winding and the semi-conductive shield. Since the winding structure uses a mature technology such as PCB manufacturing, there are no air bubbles inside the PCB structure which leads to a partial discharge free operation. A terminal treatment needs to be provided to avoid partial discharge at the edges of the semi-conductive paint. However, this solution is limited to lower powers since the polyamide material used in the PCB is typically of low thermal conductivity. In addition, due to the planar nature of the winding structure itself, at high frequencies, the winding experiences proximity losses which reduces the efficiency of the transformer. Combining both the effects, the power level for such a transformer becomes limited.

In other designs, as seen in [4], an airgap (introduced by the insulating divider P108 ) is provided between the cores P104/P106 which separates the transformer P102 into two parts: a medium-voltage side (primary circuit 10S) and a low-voltage side (secondary circuit 20S). The medium-voltage winding P114 is wrapped around one part P104 of the core which is at a medium-voltage potential Vin and the low-voltage winding P116 is wrapped around the other part P106 of the core which is at a low-voltage potential Vout (see FIG. 4). Due to the airgap, the magnetic core P104/P106 now separates into two voltage potentials, and the total voltage is applied to the space between the cores P104/P106. This solution solves the insulation challenge but invites other issues. Since an airgap is necessary to achieve this insulation, the electrical performance is now coupled with the insulation design. For certain applications, a pre-defined range of gap is preferred which limits the insulation capacity of the transformer. Increasing the gap will decrease the magnetizing inductance and increase the magnetizing current, leading to lower efficiencies. Moreover, the gap cannot be made arbitrarily big since it reduces the coupling between the primary and the secondary side. This provides a limit on the insulation capability of such a design.

A coaxial structure, as shown in FIG. 5 can be used to form a medium-voltage transformer structure [5]. The insulation is formed via the coaxial cable 10T structure winding around the core 40T and connecting to the high potential connection 20T and the low potential connection 30T due to which there is no secondary process required. This forms a good concept for a 1:1 turns ratio design. However, it is challenging to implement a design that requires a non-unity turns ratio. Further, due to the inherent design of the winding itself, a smaller bend radius is typically difficult to achieve and can lead to cracks in the structure. The coaxial structure further includes bobbin 50T for the coaxial cable 10T to wind, mounting flanges 60T, and cable boxes 70T.

To mitigate all these challenges, a scalable, modular, easy-to-manufacture, environmentally friendly solution is preferred for medium-voltage applications. The solution needs to be partial discharge free at the rated operating conditions, have high efficiency and low loss, and not require repetitive maintenance (dry type solution is preferred).

Reference [6], [7] shows a transformer with double semi-conductive layers 10U and 20U to overcome the litz wire potting challenge. The insulation design of transformer winding 50U is shown in FIG. 6. This insulation design is complex and has multiple insulation layers 30U and 40U. Especially, the first insulation layer 30U between the litz wire winding and the first semi-conductive layer 10U causes complex fabrication process and prohibits heat flux of winding loss to dissipate. This disclosure presents a transformer of medium-voltage isolation aiming to simply the insulation structure and thus the fabrication process and cost.

REFERENCE documents are as follows: [1] X. She, A. Q. Huang and R. Burgos, "Review of Solid-State Transformer Technologies and Their Application in Power Distribution Systems," in IEEE Journal of Emerging and Selected Topics in Power Electronics, vol. 1, no. 3, pp. 186-198, Sep. 2013, doi: 10.1109/JESTPE.2013.2277917. [2] N. Djekanovic and D. Dujic, "Design Optimization of a MW-level Medium Frequency Transformer," PCIM Europe 2022; International Exhibition and Conference for Power Electronics, Intelligent Motion, Renewable Energy and Energy Management, Nuremberg, Germany, 2022, pp. 1-10, doi: 10.30420/565822101. [3] Wang, Ruxi, et al. "Planar winding structure for power transformer." U.S. Patent Application No. 17/471,142. [4] Hesterman, Bryce Leonard, and Dorai Babu Yelaverthi. "High frequency medium voltage transformer with central insulating divider." U.S. Patent Application No. 18/097,183. [5] L. Heinemann, "An actively cooled high power, high frequency transformer with high insulation capability," APEC. Seventeenth Annual IEEE Applied Power Electronics Conference and Exposition (Cat. No.02CH37335), Dallas, TX, USA, 2002, pp. 352-357 vol.1, doi: 10.1109/APEC.2002.989270. [6] CN 114792598 B, “Transformer winding with internal shielding structure and design method thereof”. [7] R. Lu, C. Li, J. Yu, C. Li, W. Li and X. He, "Modeling and Design of Insulation Structure for High Power Density Medium Voltage High-Frequency Transformers," in IEEE Journal of Emerging and Selected Topics in Power Electronics, vol. 11, no. 6, pp. 6005-6015, Dec. 2023.

### SUMMARY

In the present disclosure, a medium-voltage isolation transformer which provide at least one of these advantages are provided.

In order to achieve the above-mentioned object of the disclosure, one embodiment of the disclosure provides a medium-voltage isolation transformer, including: a low-voltage winding; a magnetic core; and a medium-voltage winding assembly, wherein the low-voltage winding is exposed in air, the medium-voltage winding assembly including: a medium-voltage winding; and a potting material body, wherein the medium-voltage winding is embedded inside the potting material body, the potting material body is filled with potting material, and the medium-voltage winding is configured by litz wire whose external surface is covered by a first semi-conductive layer.

Optionally, the potting material body is provided with a duct, and terminals of the medium-voltage winding come out from the duct of the potting material body.

Optionally, the duct is provided with a top opening and comprises a plurality of fin structure disposed outside the duct.

Optionally, the plurality of fin structure is larger near the low-voltage winding than other sides.

Optionally, the fin structure near the medium-voltage winding comprises a cover structure partially covering the medium-voltage winding.

Optionally, the potting material body further comprising two bushing structures for the magnetic core to pass through and separating the magnetic core from the medium-voltage winding.

Optionally, the first semi-conductive layer comprises at least one of a semi-conductive heat shrink tube covering the litz wire or a semi-conductive tape wrapped around the litz wire.

Optionally, the medium-voltage isolation transformer further includes a second semi-conductive layer applied to an external surface of the potting material body.

Optionally, the medium-voltage isolation transformer further includes a connection cable connected between the second semi-conductive layer and an end of the low-voltage winding.

Optionally, the medium-voltage isolation transformer further includes a connection cable connected between the second semi-conductive layer and a direct current output of a low-voltage circuit for the low-voltage winding.

Optionally, the first semi-conductive layer is electrically connected to conductors of two ends of the litz wire.

The embodiment of the disclosure presents a transformer whose isolation between primary and secondary windings can sustain medium-voltage stress. The transformer’s primary winding is made of litz wire with a first semi-conductive layer. The first semi-conductive layer is electrically connected to two ends of the litz wire. The primary winding is potted with insulation material. There is a second semi-conductive layer on the outer surface of the insulation material potting. The second semi-conductive layer outside the potting is electrically connected to the secondary winding. The electrical connection between the second semi-conductive layer and the secondary winding can be direct or indirect.

Embodiments of the present disclosure can provide confined electric field and hence lead to a partial discharge free design in medium-voltage applications. Unlike conventional techniques, where typically the winding structure is encapsulated to provide the required isolation, this disclosure relies on provided a semi-conductive layer to shield one of the windings and provide a confined electric field. This helps in creating a reliable manufacturing process to create the transformer and increase its manufacturability. For the transformer structure of the embodiments, the two windings are designed to be interchangeably used and hence the medium-voltage side and the low-voltage side can be used for either winding. This transformer can be used as either a unity turns-ratio based transformer or a step-up/step-down based transformer without any limitations.

### BRIEF DESCRIPTION OF THE SEVERAL VIEWS OF THE DRAWINGS

FIG. 1 shows an example of isolation transformers in a solid-state transformer in prior art.

FIGS. 2A and 2B illustrate a conventional litz wire transformer solution which can be immersed in oil for higher insulation capacity.

FIG. 3 illustrates a prior art PCB based transformer design which uses the PCB structure and a shielding layer to achieve the required medium-voltage insulation.

FIG. 4 illustrates a prior art structure where an air gap is provided between the primary and the secondary side of the core.

FIG. 5 illustrates a conventional solution of using a coaxial structure to form the transformer’s primary and secondary sides.

FIG. 6 shows a prior art transformer with double semi-conductive layers to overcome the litz wire potting challenge

FIG. 7 illustrates a perspective view of a power transformer with a potted core-based structure, in accordance with an embodiment of the present disclosure.

FIG. 8 illustrates a sectional view along line A-A of the power transformer in FIG. 7, in accordance with an embodiment of the present disclosure.

FIG. 9 illustrates a sectional view along line B-B of the power transformer in FIG. 7, in accordance with an embodiment of the present disclosure.

FIGS. 10A-10F illustrates various embodiments of the core structure.

FIGS. 11A-11E illustrates various embodiments of the support structure.

FIGS. 12A-12C illustrates a variation of the encapsulation structure to achieve the required clearance and creepage requirements while providing space for air flow.

FIGS. 13A and 13B illustrate an electric field E simulation result for the structure based on FIG. 8 for a voltage difference of 20 kV between the windings.

FIGS. 14A and 14B illustrate an electric field E simulation result for the structure based on FIG. 9 for a voltage difference of 20 kV between the windings.

FIGS. 15A-15C shows a perspective view, side view, and front view of a medium-voltage isolation transformer according to one embodiment of the disclosure.

FIG. 16 shows an exploded view of a medium-voltage winding assembly.

FIG. 17 shows a cross-section view of the medium-voltage winding assembly where the medium-voltage winding is placed in inside the potting material body.

FIG. 18 A shows a method of using semi-conductive heat shrink tube.

FIG. 18B shows a method of using semi-conductive tape.

FIG. 19 shows a second semi-conductive layer is applied to the external surface of the potting material body.

FIG. 20A shows a direct connection of the second semi-conductive layer to the low-voltage winding.

FIG. 20B shows an indirect connection case where a connection cable is added from the second semi-conductive layer to DC output of the low-voltage circuit (point C or point D).

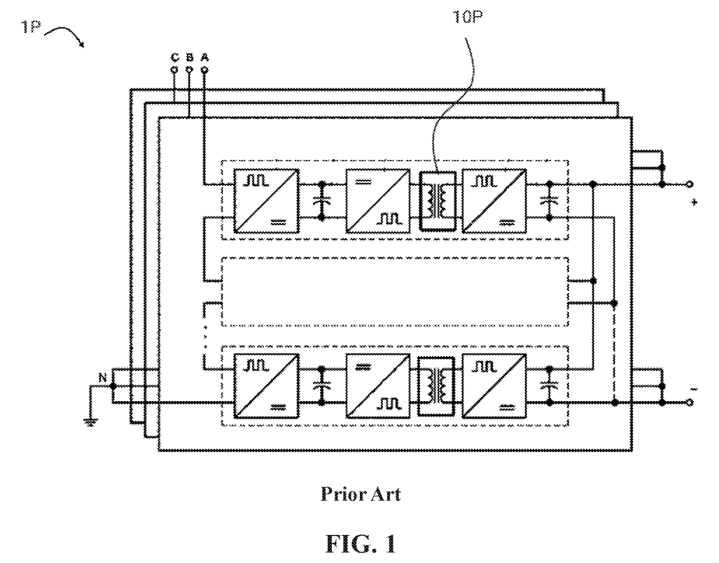

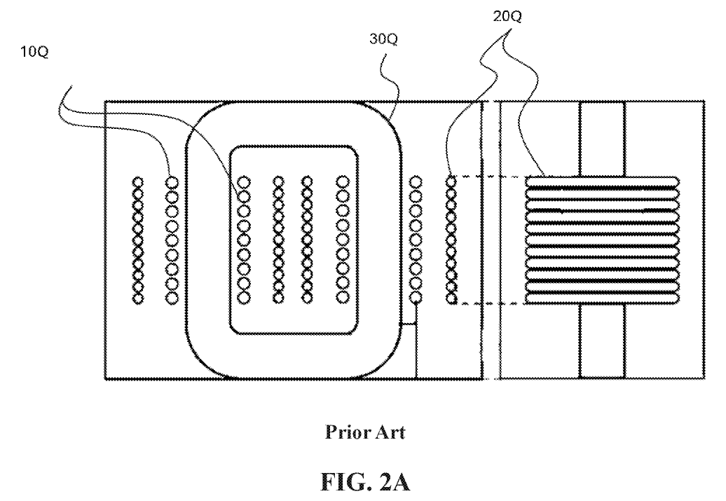

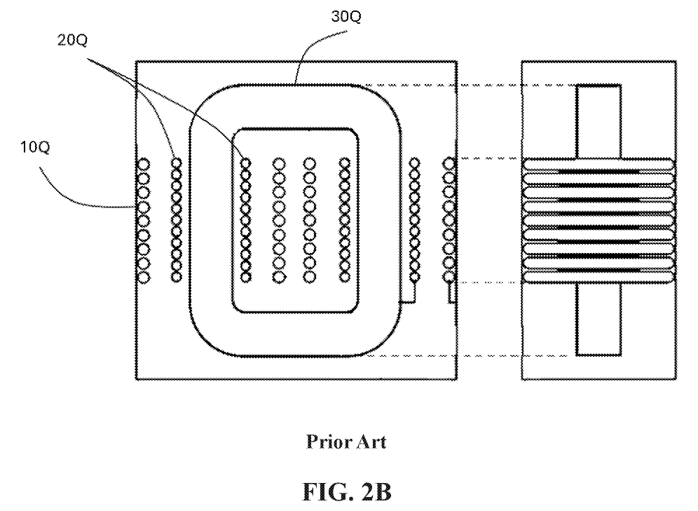

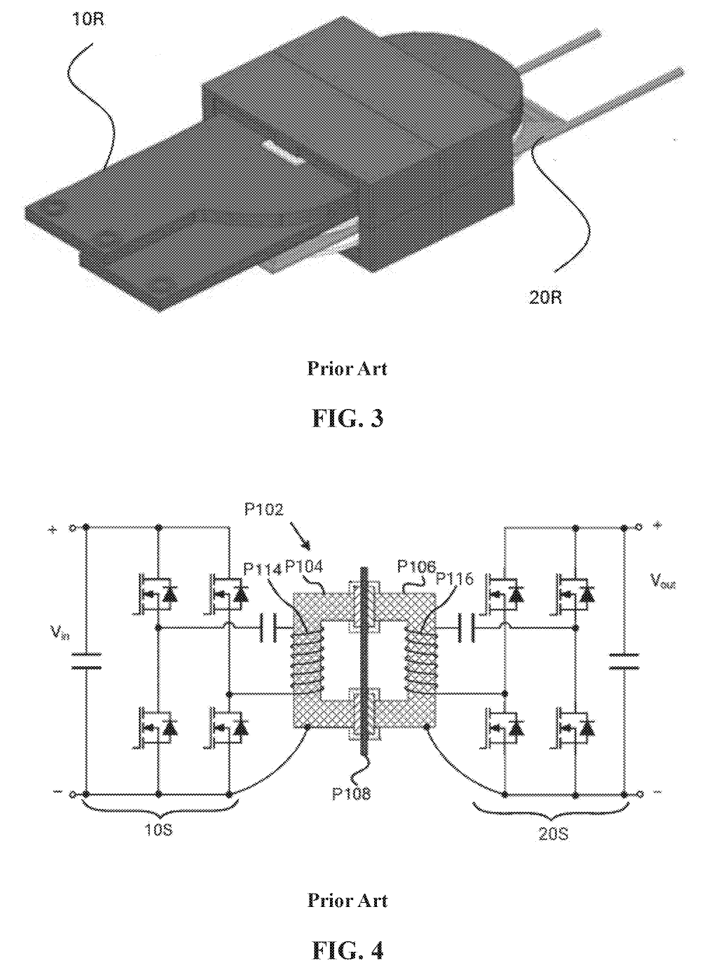

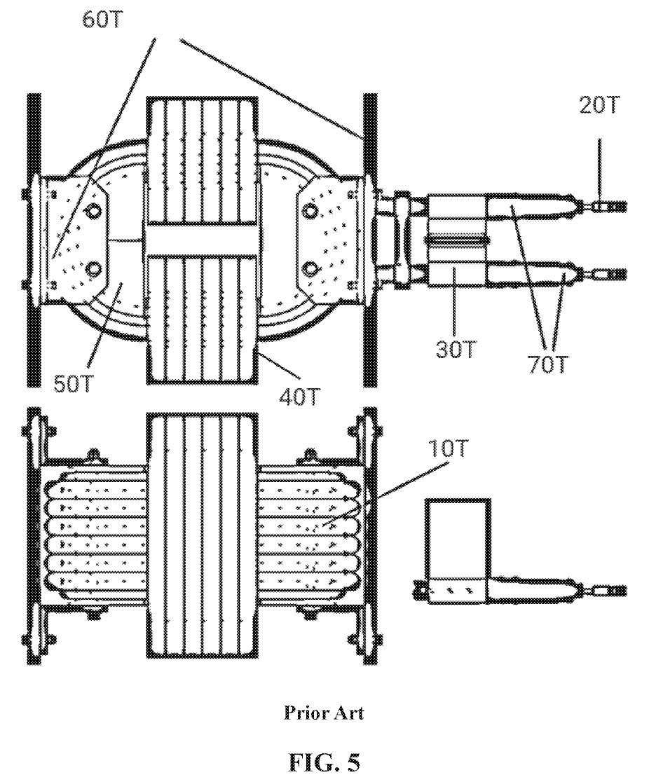

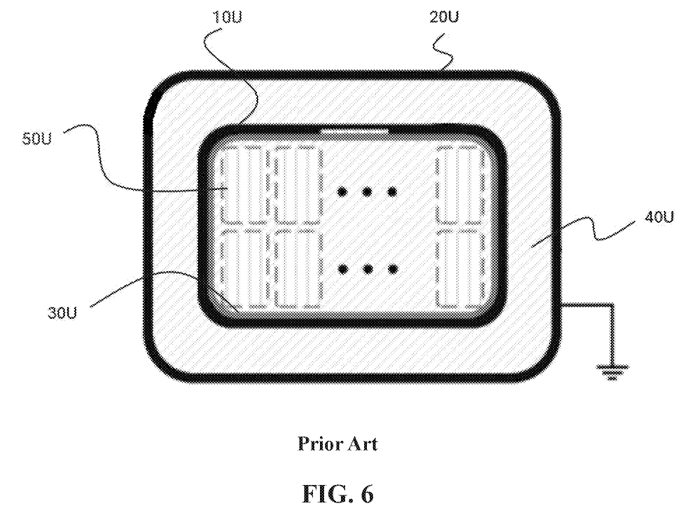

### DETAILED DESCRIPTION

In order to make the above and other objects, features, and advantages of the disclosure easier to understand, preferred embodiments of the disclosure will be illustrated below and described in detail with reference to the drawings. In addition, in the drawings, structurally similar units are represented by the same reference numerals.

Transformers are critical components in the medium system since they form the interface between the medium voltage and the low-voltage side. The reduction of the size of this transformer forms an important aspect in the reduction of the size of the entire system. Increasing the operating frequency of the transformer leads to smaller size and weight of the transformer while retaining all the inherent functions. However, when the size of the transformer is reduced, it becomes increasingly difficult to achieve the voltage isolation between the primary and secondary side. Secondly, due to the smaller size, it becomes more challenging to extract the heat from the system. In some embodiments, the transformer might need to be free of partial discharge at rated operating conditions, provide easy manufacturability, and provide maintenance free operation throughout its lifetime.

In the embodiments of the present disclosure, techniques to design power transformers which provide all these advantages are provided. Embodiments of the present disclosure can provide confined electric field and hence lead to a partial discharge free design in medium-voltage applications. Unlike conventional techniques, where typically the winding structure is encapsulated to provide the required isolation, the embodiment of the disclosure relies on provided a semi-conductive layer to shield one of the windings and provide a confined electric field. This helps in creating a reliable manufacturing process to create the transformer and increase its manufacturability. For the proposed transformer structure, the two windings are designed to be interchangeably used and hence the medium-voltage side and the low-voltage side can be used for either winding. This transformer can be used as either a unity turns-ratio based transformer or a step-up/step-down based transformer without any limitations.

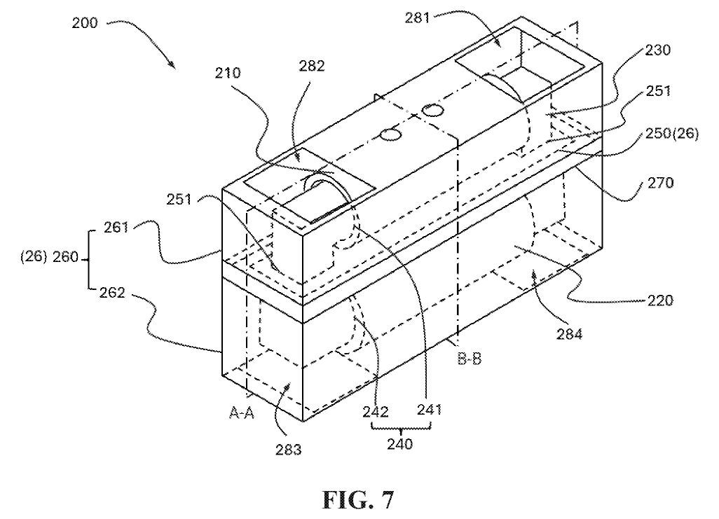

FIG. 7 illustrates a perspective view of a power transformer with a potted core-based structure, in accordance with an embodiment of the present disclosure. A power transformer 200 includes a first winding 210, a second winding 220, a core structure 230 configured to transfer power between the first winding 210 and second winding 220, and an isolating structure 26 provided with an insulating material or a semi-conductive material to separate the first winding 210 and the second winding 220 and to cover part of the core structure 230. Referring to FIG. 7, the first winding 210, which can either be a medium-voltage winding or a low-voltage winding wrapped around a bobbin structure 240 which may be built using any insulating material or semi-conductive material. If an insulating material is used, a semi-conductive material may be painted on it which connects to the core structure 230 electrically to form an equipotential surface with the core structure 230. The bobbin structure 240 can have no semi-conductive paint applied to the insulating material in case a core potential is controlled by other means. The second winding 220 which also can be either the medium-voltage winding or the low-voltage winding is wrapped around the bobbin structure 240. The bobbin structure 240 includes a first bobbin 241 and a second bobbin 242. Like the first winding 210, insulating material or semi-conductive material might be used in second bobbin 242. However, it does not intend to control a core potential of the second winding 220, which is why the semi-conductive material application on the bobbin is optional.

The isolating structure 26 may include one or more insulating materials like FR4, nylon, acrylic, resin etc. with a certain amount of thickness which is able to block the required medium voltage between the medium voltage terminals and the low voltage terminals. The aim of having this structure is to provide the required clearance and creepage requirements for the transformer structure.

Components of the semi-conductive material may include base material (such as PTFE, EPDM), conductive material (conductive filler, metal mesh, etc.), and adhesive (acrylic resin, etc.). The combination of these components makes the semi-conductive material semi-conductive and can effectively perform functions such as electrostatic protection or electrical shielding.

Referring again to FIG. 7, the isolating structure 26 includes an encapsulation structure 260 and a semi-conductive layer 250 connected to the core structure 230 and using semi-conductive paint, or solid connection. The semi-conductive layer forms an equipotential surface with the core structure 230. Through holes 251 are provided on a semi-conductive surface of the semi-conductive layer 250 to accommodate the magnetic cores therein. The semi-conductive surface of the semi-conductive layer 250 provides a shield to the first winding 210 and helps to confine an electric field inside the encapsulation structure 260.

Referring again to FIG. 7, a support structure 270 for the potting is manufactured with insulating material or semi-conductive material. The support structure 270 may be manufactured in a multi-piece structure to ease physically insertion of the core structure 230. The support structure 270 encloses a lower portion of the core structure 230 and forms an encasing for filling potting material 274 to form a potted core. The semi-conductive layer 250 is applied to the external surface of the support structure 270 to create an equipotential surface. Potential of a surface of the semi-conductive layer 250 is maintained close to potential of the second winding 220. Because the surface is maintained close to the potential of the second winding 220, an entire electric field is confined to the encapsulation structure 260 and the support structure 270.

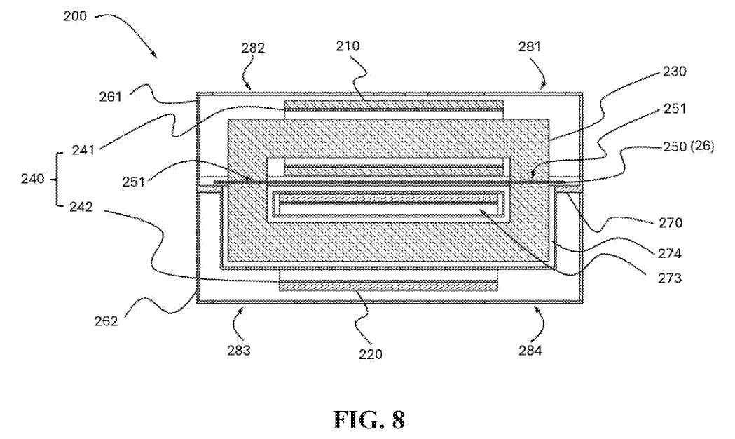

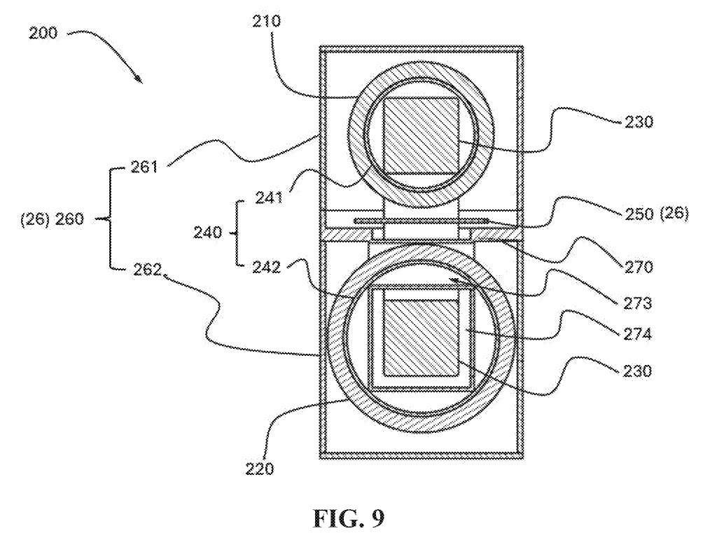

FIG. 8 illustrates a sectional view along line A-A of the power transformer structure in FIG. 7, in accordance with an embodiment of the present disclosure. FIG. 9 illustrates a sectional view along line B-B of the power transformer structure in FIG. 7, in accordance with an embodiment of the present disclosure.

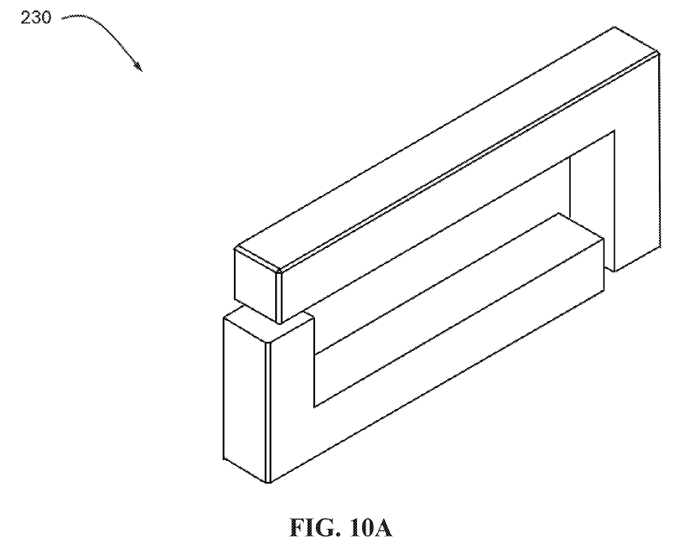

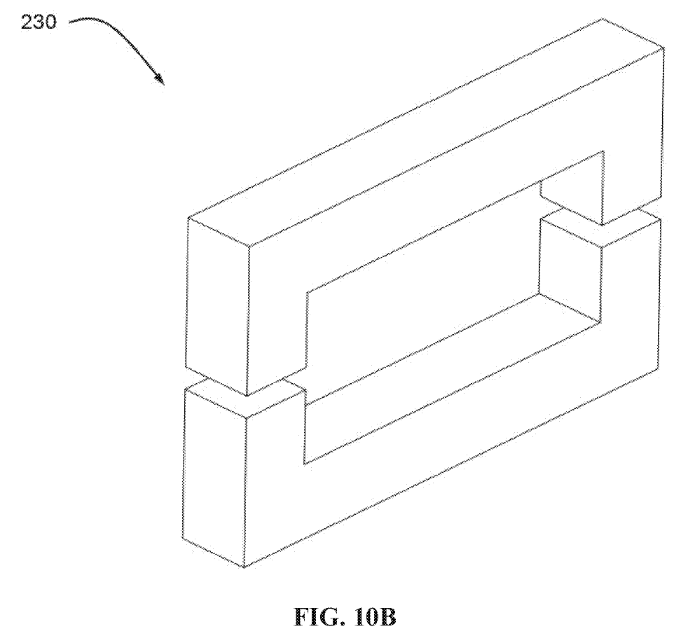

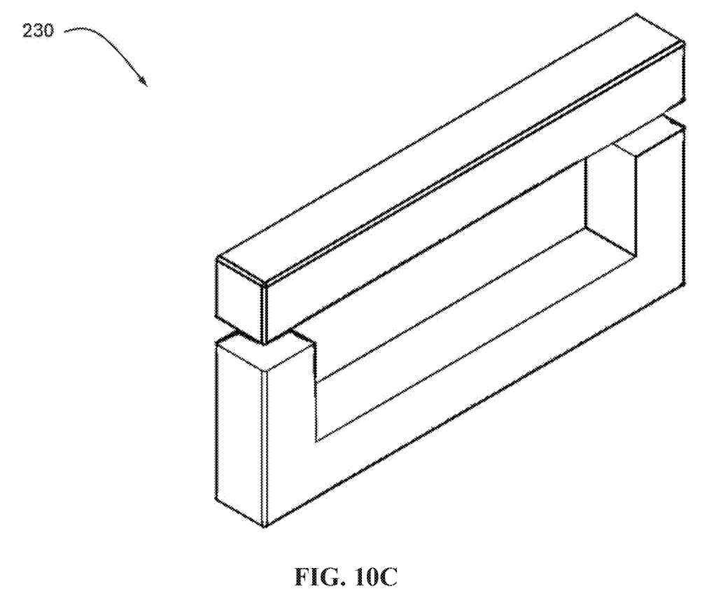

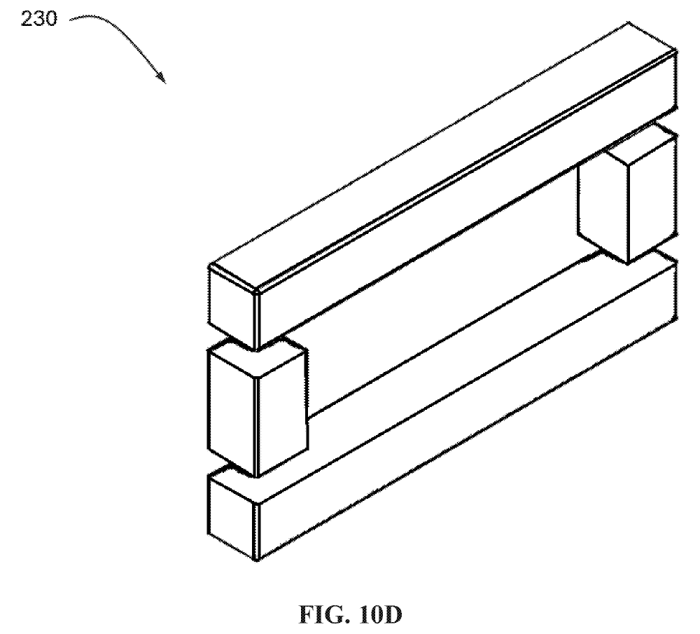

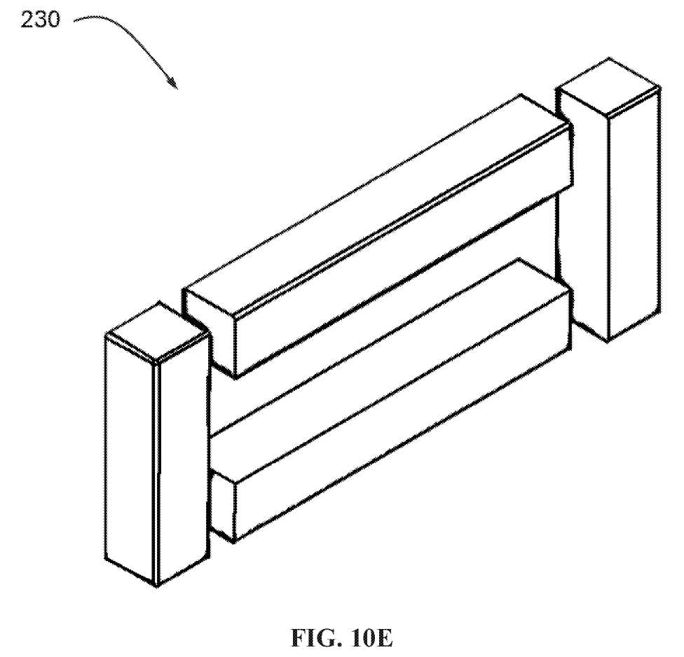

FIGS. 10A-10F show various embodiments of the core structure 230. The core structure 230 can be divided into a number of pieces for easier manufacturability of both the core structure 230 as well as structure of the power transformer. A few examples of how the core structure 230 can be divided are shown in FIGS. 10A-10E. It should be noted that the core structure can be divided in any other way provided it eases the manufacturability process and does not make the assembly difficult to make. One of generic examples of the core structure being separated into several pieces is provided in FIG. 10F. The core structure is divided into smaller pieces in both directions and depending on the size, the core structure can be distributed into several smaller structures.

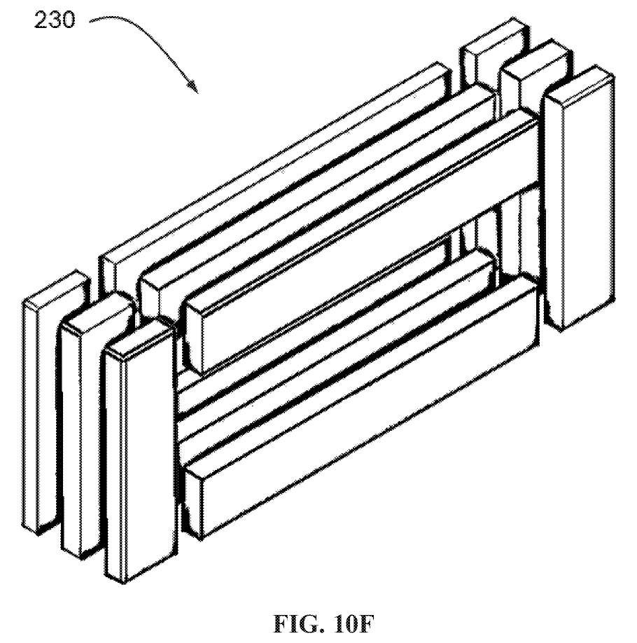

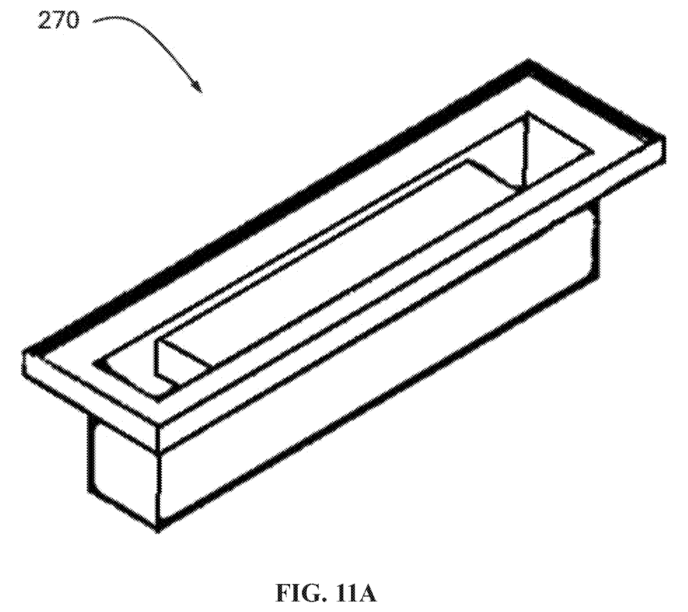

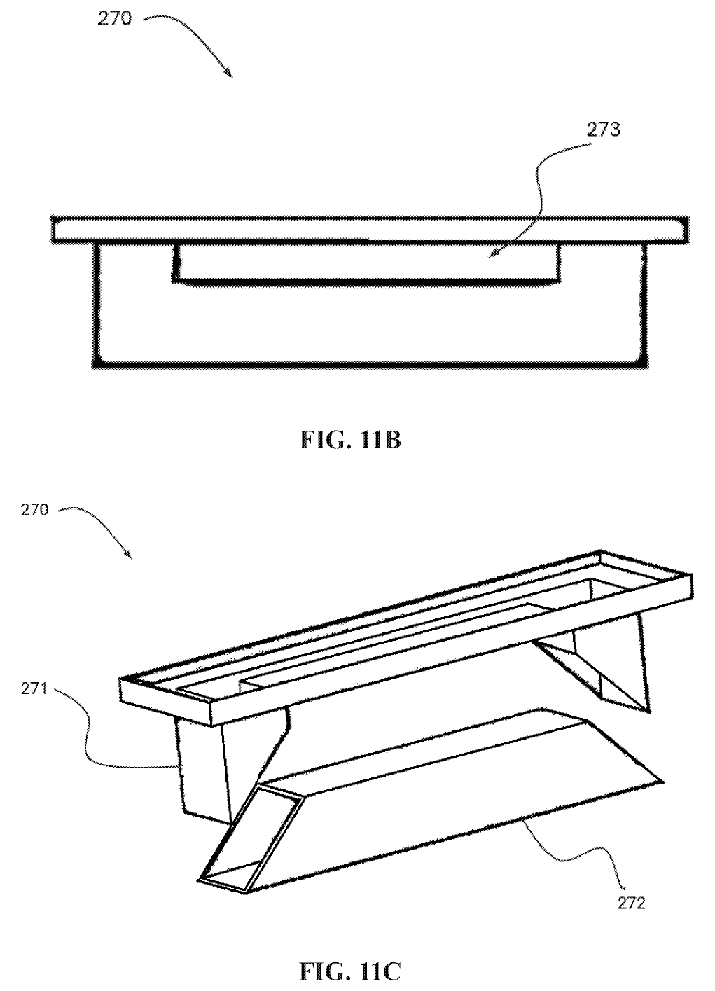

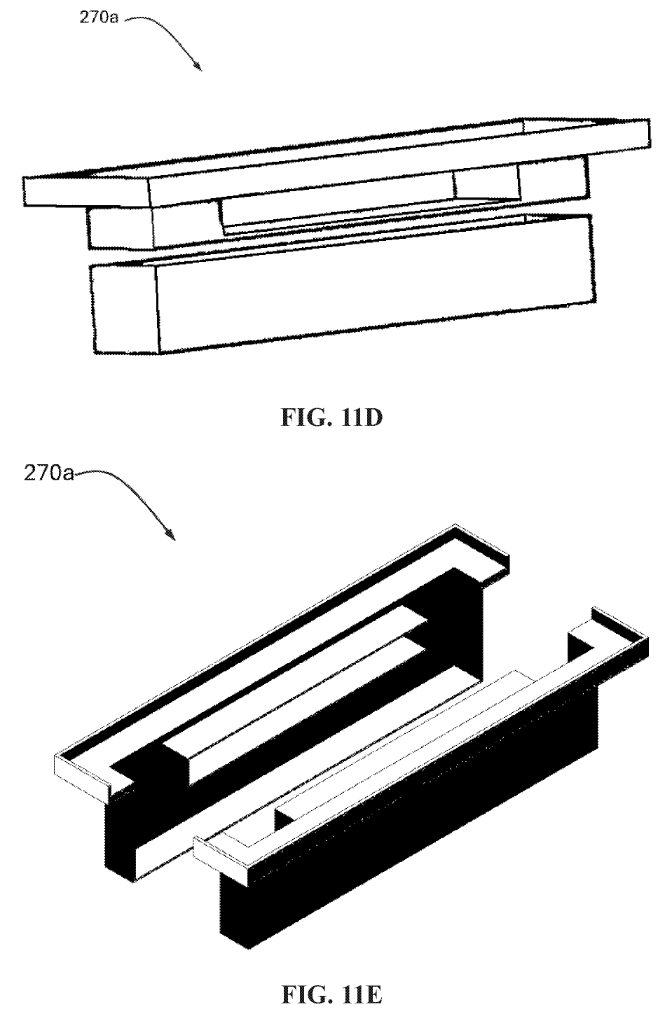

FIGS. 11A and 11B shows the support structure 270 used for potting. In the embodiment, the support structure 270 is created as a separate piece. In the embodiment, the support structure 270 is not a single piece structure because the second winding 220 and the second bobbin 242 for the second winding 220 would be inserted into the gap 273. One of the methods for realizing this structure is by dividing the support structure 270 into a first part 271 and a second part 272 as shown in FIG. 11C. The core structure which can be realized using four or more separate I-cores, L-cores, U-cores, or combination as shown in FIGS. 10A-10E can be inserted into the second part 272 of the support structure 270. The second bobbin 242 can also be inserted onto the second part 272 of the support structure 270 after which the second part 272 can be glued to the first part 271 creating a single structure. FIGS. 11D and 11E give another example of design for separating the support structure 270a. There can be variations of the example of design for separating the support structure and the support structure can be divided into a greater number of parts that makes it easier and possible to manufacture.

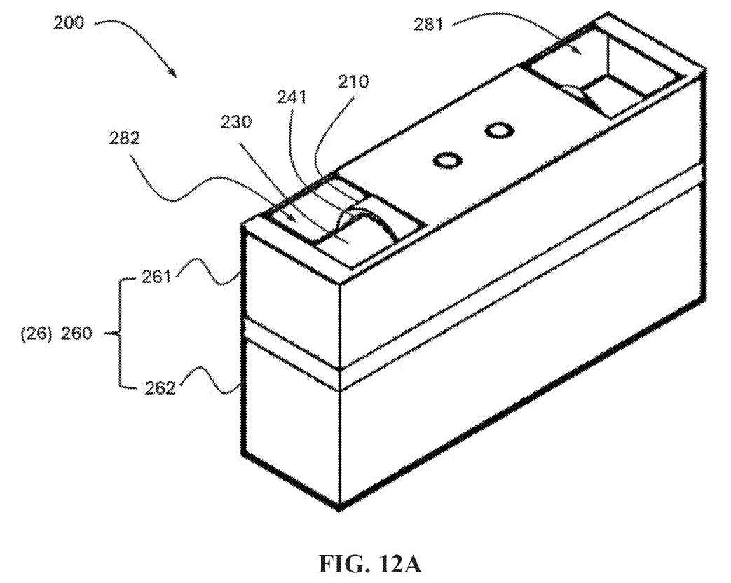

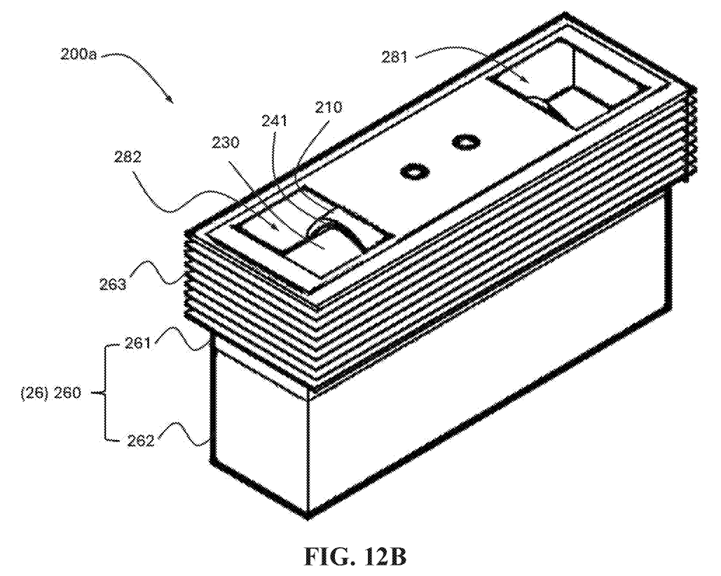

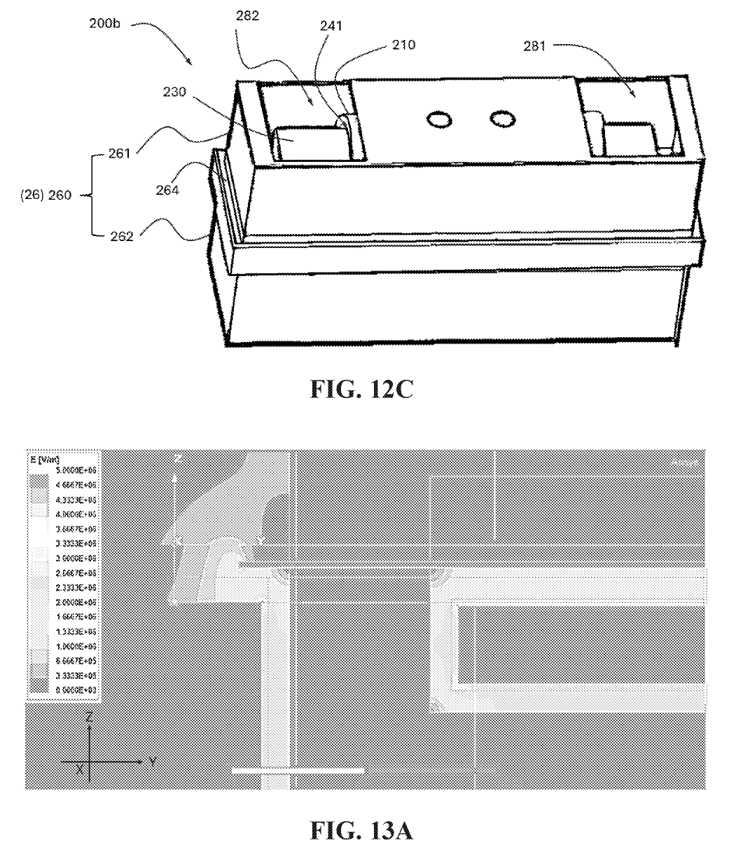

Referring to FIG. 12A, the encapsulation structure 260 of the power transformer 200 is defined. The external encapsulation structure 260 is manufactured with insulating material and is used to provide the required clearance and creepage for medium voltage of the power transformer 200. FIG. 12B shows another embodiment of power transformer 200a to increase the clearance and creepage between the first winding 210 and the second winding 220 (not shown in FIG. 12B, refer to FIG. 7). Ridges 263 can be provided on the encapsulation structure 260 to improve the creepage distance between the first winding 210 and the second winding 220. The clearance can also be improved if the teeth of the ridges 263 can be extended. However, this might lead to loss in power density and increased size. The encapsulation structure 260 includes a first external structure 261 and a second external structure 262. In FIG. 12B, the ridges 263 are shown only on the first external structure 261 as an example. However, they can be applied to either the first external structure 261, the second external structure 262, or to both depending on the requirement. In FIG. 12A, a first opening 281 and a second opening 282 for the airflow are provided. A third opening 283 and a fourth opening 284 for the second winding 220 are shown in FIG. 7. In the present embodiment, openings for the airflow are provided on a top and a bottom of the power transformer 200/200a. This allows for a higher clearance between two openings. Ideally, the opening for the airflow can be made on any plane of the encapsulation structure 260. External wiring connections may also be made through these planes. The encapsulation structure 260 has no openings apart from the openings for air flow and for the electrical connections.

In case of a two-piece structure including the first external structure 261 and the second external structure 262, slot between two pieces may be sealed for achieving the required clearance and creepage in the present embodiment. A power transformer 200b of the embodiments to seal the edge is shown in FIG. 12C where a slot between the first external structure 261 and the second external structure 262 can be filled with an encapsulating material 264 after assembling the first external structure 261 and the second external structure 262. In the embodiment in FIG. 12A, a slot (not shown) is provided on internal side of the encapsulation structure 260, and a similar procedure is followed to seal the slot. The encapsulation structure 260 is inherently used to increase the clearance and creepage between two potentials. The creepage of the encapsulation structure 260 can be further improved by providing grooves/ridges on external side of the encapsulation structure 260 as shown in FIG. 12B.

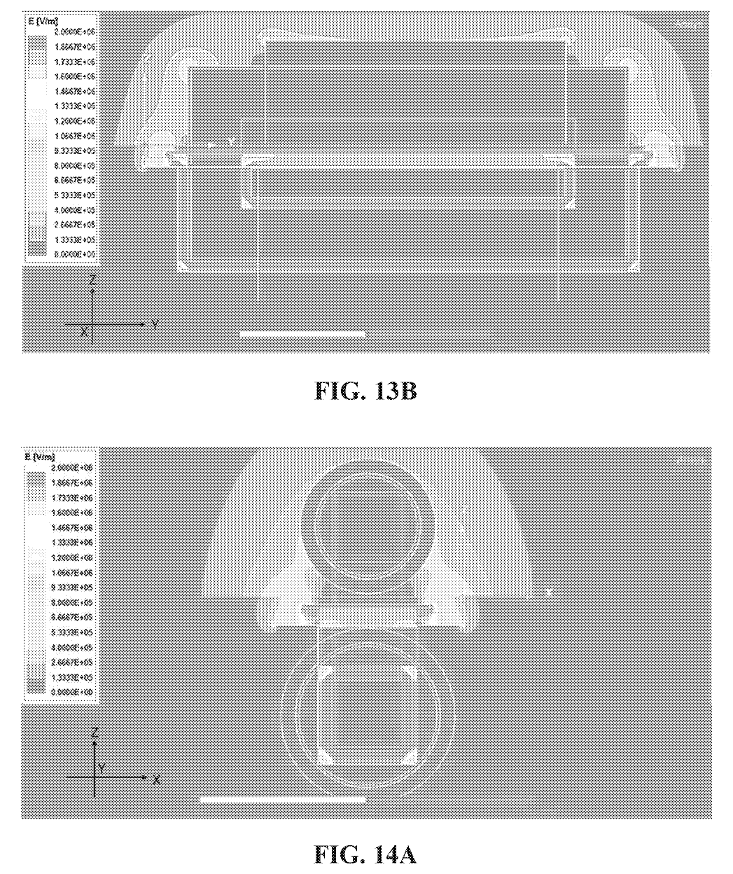

FIGS. 13A-13B show the electric field simulations of an exemplary structure based on the embodiment of FIG. 8. A voltage of +20 kV is applied to the core and the first winding 210, and a voltage of 0 V is applied to the second winding 220 in order to estimate the electric field stress obtained from the structure. From FIG. 13A, whose legend shows a peak electric field of 5 kV/mm, it is seen that the electric field inside the encapsulation structure is well with the limits (and is close to 3 kV/mm) for the current design and encapsulation material. FIG. 13B showcases the same information but the legend is capped at 2 kV/mm to showcase the electric field in the air. It is seen that for the current design, the electric field in air is well within the limits of 2 kV/mm.

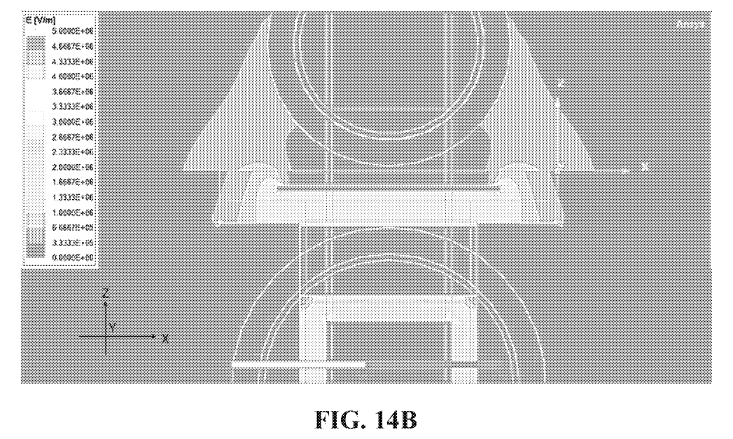

FIGS. 14A and 14B showcases the electric field simulations based on the embodiment of FIG. 9. A voltage of +20 kV is applied to the core and the first winding 210, and a voltage of 0 V is applied to the second winding 220 in order to estimate the electric field stress obtained from the structure. From FIG. 14A, whose legend shows a peak electric field of 5 kV/mm, it is seen that the electric field inside the encapsulation structure is well with the limits (and is close to 3 kV/mm) for the current design and encapsulation material. FIG. 14B showcases the same information but the legend is capped at 2 kV/mm to showcase the electric field in the air. It is seen that for the current design, the electric field in air is well within the limits of 2 kV/mm.

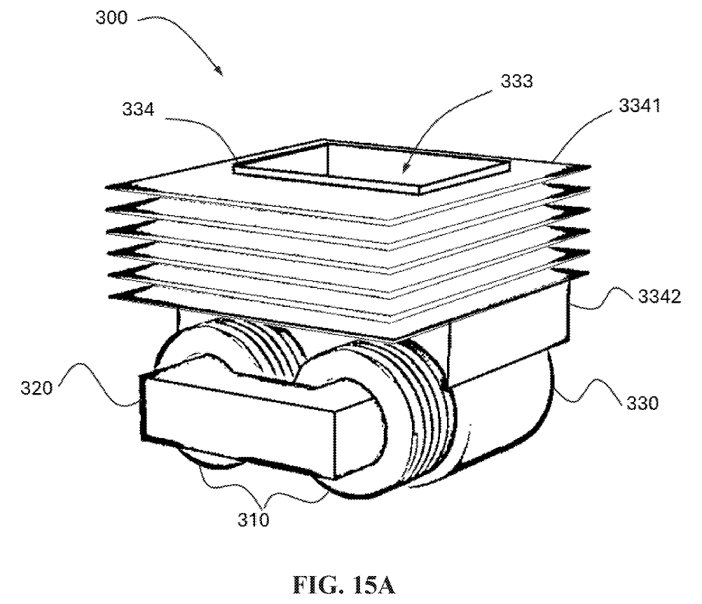

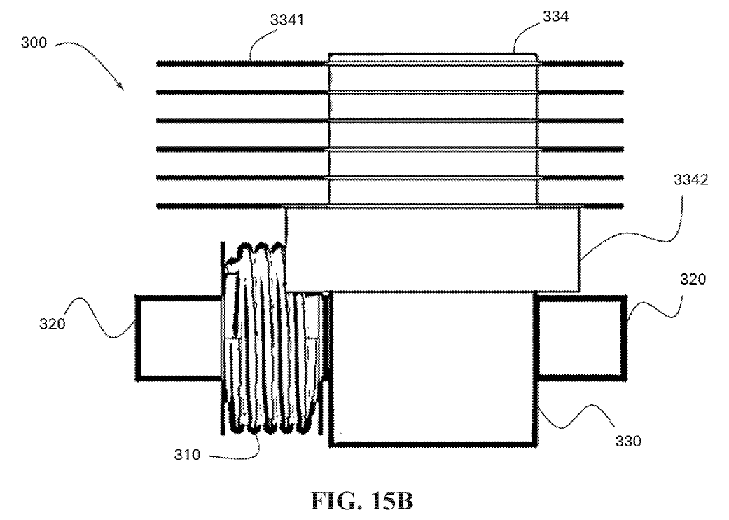

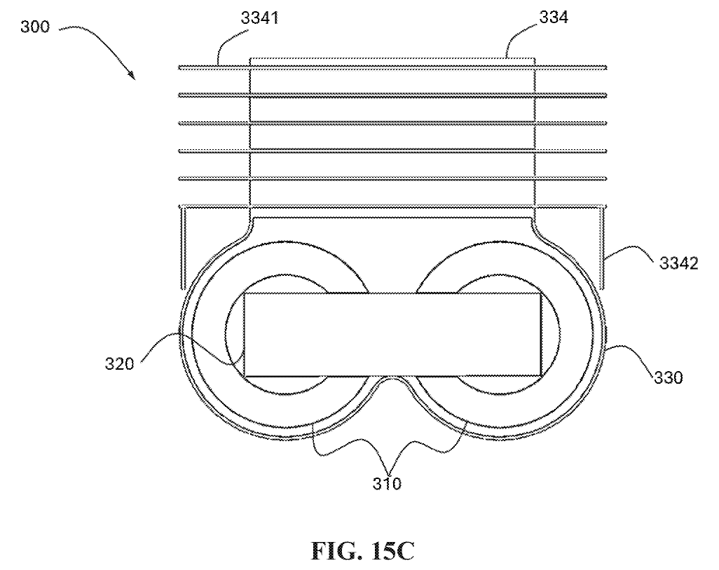

The embodiment of the present disclosure further discloses a medium-voltage isolation transformer whose isolation between the primary and secondary windings can sustain medium-voltage stress. FIGS. 15A-15C shows the components forming the medium-voltage isolation transformer 300 of the embodiment. The medium-voltage isolation transformer 300 includes three main parts: a low-voltage winding 310, a magnetic core 320, and a medium-voltage winding assembly 330. The low-voltage winding 310 is exposed in air without any semi-conductive layer covering their surfaces. Parts of the magnetic core 320 not covering by the low-voltage winding 310 and the medium-voltage winding assembly 330 are exposed in air without any semi-conductive layer covering their surfaces. In the embodiment of FIGS. 15A-15C, similar to the embodiment in FIG. 7, the medium-voltage isolation transformer 300 is known as the transformer, the low-voltage winding 310 is known as the first winding, the medium-voltage winding 331 is known as the second winding, and the magnetic core 320 is known as the core structure, in which the core structure transfers power between the first winding and second winding, the isolating structure is provided with an insulating material or a semi-conductive material to separate the first winding and the second winding and to cover part of the core structure.

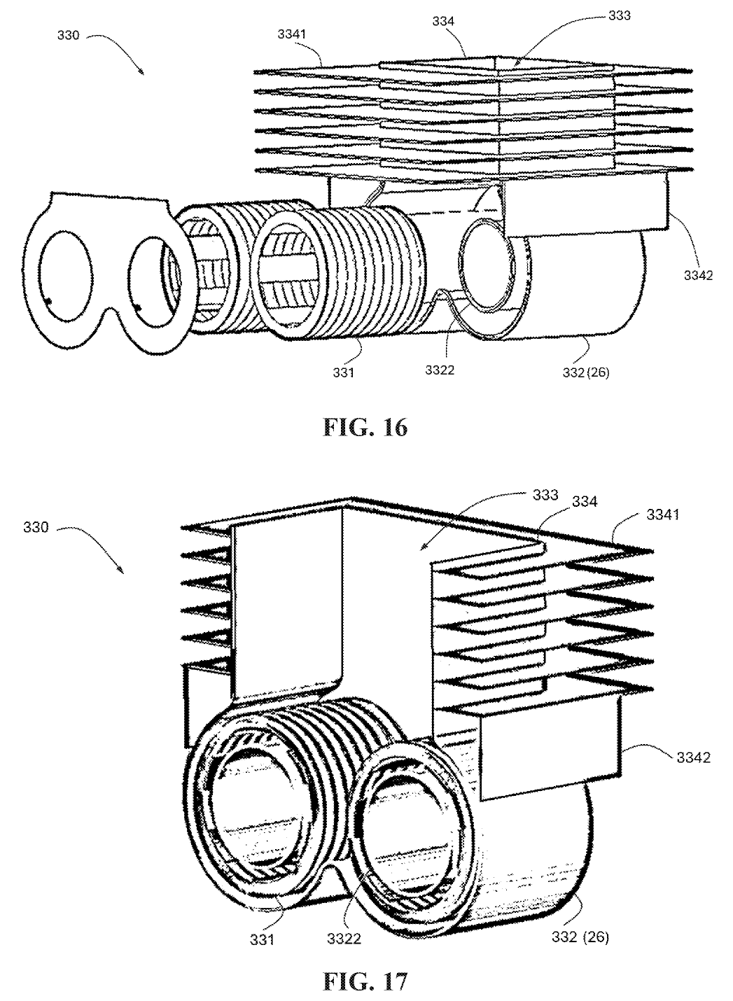

FIG. 16 shows an exploded view of the medium-voltage winding assembly 330. In the embodiment, the medium-voltage winding assembly 330 includes two main parts: medium-voltage winding 331 and potting material body 332 (including in isolating structure). Medium-voltage winding 331 is embedded inside the potting material body 332. The low-voltage winding 310 and the medium-voltage winding 331 are wound around the magnetic core 320. Potting material body 332 is filled with potting material (not shown). In one embodiment, the potting material body 332 is fully filled with potting material (not shown).

Optionally, the potting material body 332 is provided with a duct 334, and terminals of the medium-voltage winding 331 come out from the duct 334 of the potting material body 332.

Optionally, the duct 334 is provided with a top opening 333 and comprises a plurality of fin structure 3341 disposed outside the duct 334.

Optionally, the plurality of fin structure 3341 is larger near the low-voltage winding 310 than other sides.

Optionally, the fin structure 3341 near the medium-voltage winding 331 comprises a cover structure 3342 partially covering the medium-voltage winding 331.

Optionally, the potting material body 332 further comprising two bushing structures 3322 for the magnetic core 320 to pass through and separating the magnetic core 320 from the medium-voltage winding 331.

FIG. 17 shows the cross-section view of the medium-voltage winding assembly 330 where the medium-voltage winding 331 is placed inside the potting material body 332. Filled potting material is not shown in FIGS. 16 and 17 for view simplicity. Medium-voltage winding terminals come out from the top opening 333 of the potting material body 332.

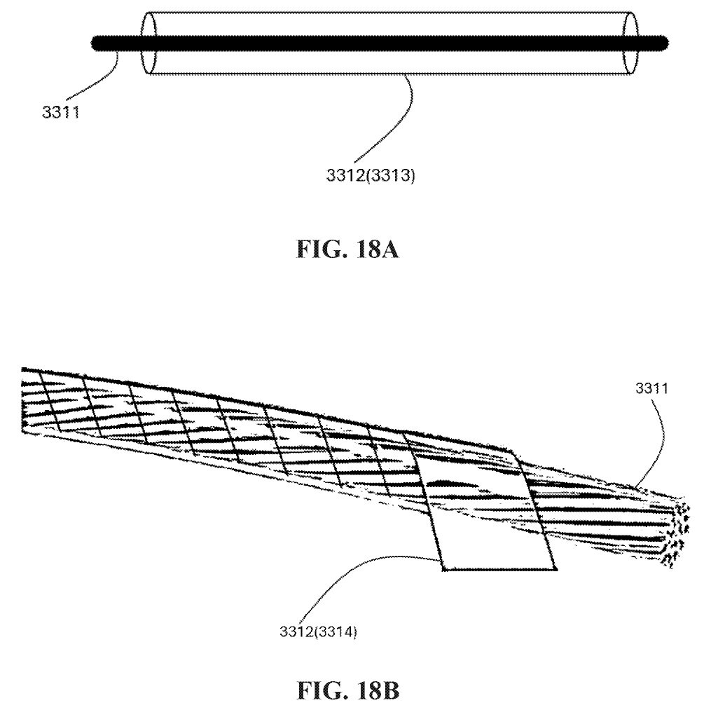

Medium-voltage winding 331 is formed by litz wire 3311 whose external surface is covered by a first semi-conductive layer 3312. This can be done using semi-conductive heat shrink tube or using semi-conductive tape. These two methods are shown in FIGS. 18A and 18B. FIG. 18A shows a method of using semi-conductive heat shrink tube. The litz wire 3311 first passes through the semi-conductive heat shrink tube 3313. Then the semi-conductive heat shrink tube 3313 is heated up and thus uniformly applied to the litz wire 3311. FIG. 18B shows another method of using semi-conductive tape. The semi-conductive tape 3314 is wrapped around the litz wire 3311. In both cases, the semi-conductive layer outside the litz wire 3311 is electrically connected to two ends of conductors of the litz wire 3311. In one embodiment, a conductor can be used instead of the Litz wire 3311, and the conductor can be covered with a semi-conductive heat shrink tube 3313 or a semi-conductive tape 3314. In one embodiment, the conductor is, for example, a braided conductor composed of multiple strands of wire or cable. In one embodiment, multiple conductors can be prepared, and after covering each conductor with a semi-conductive heat shrink tube 3313 or a semi-conductive tape 3314, the multiple conductors can be twisted or braided together to form the Litz wire 3311.

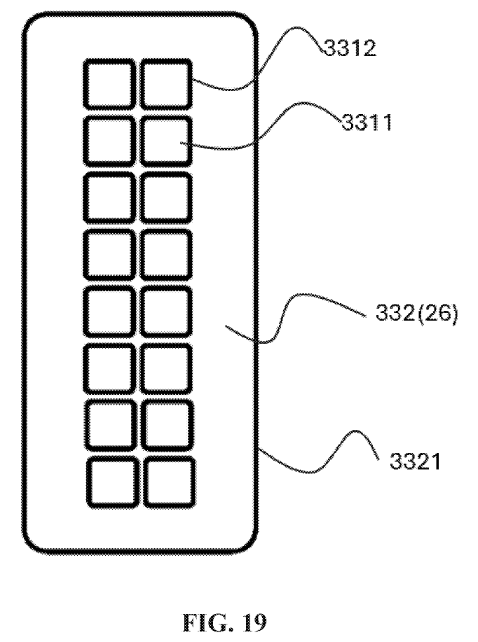

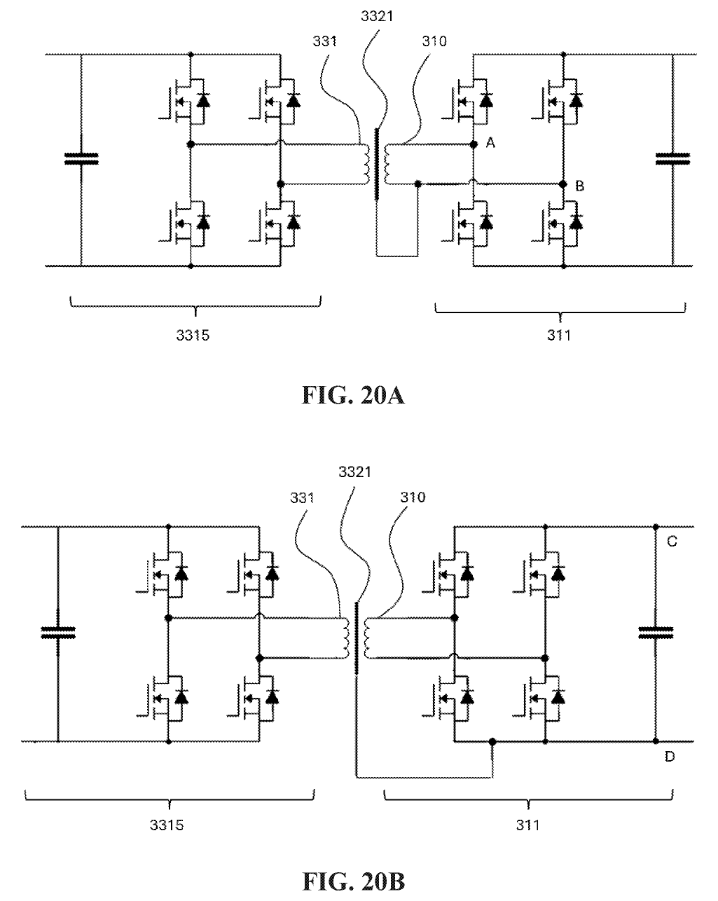

In some embodiments of the disclosure, a second semi-conductive layer 3321 is applied to the external surface of the potting material body 332. A conceptual drawing is shown in FIG. 19. The second semi-conductive layer 3321 outside the potting material body 332 is electrically connected to the low-voltage winding 310. This electrical connection can be direct or indirect, as shown in FIGS. 20A and 20B. FIG. 20A shows a low-voltage circuit 311 and a medium-voltage circuit 3315 wherein a direct connection of the second semi-conductive layer 3321 to the low-voltage winding 310. The rectifier circuits in the low-voltage circuit 311 and the medium-voltage circuit 3315 are for explanation, and the disclosure is not limited to this. A connection cable is added from the second semi-conductive layer 3321 to either end of the low-voltage winding 310 (point A or point B). FIG. 20B shows the indirect connection case where a connection cable is added from the second semi-conductive layer 3321 to DC output of the low-voltage winding 310 (point C or point D). In this way, the medium-voltage stress between the medium-voltage winding 331 and low-voltage winding 310 is constrained to potting material body 332 by the first semi-conductive layer 3312 and the second semi-conductive layer 3321. Compared to prior arts, this proposed method of the embodiment overcomes the challenges of potting litz wire and simplifies the fabrication process of the medium-voltage isolation transformer.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical value appearing in the present disclosure are deemed modified by a term of degree (e.g., “about”), thereby reflecting its intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

What is claimed is:

1. A medium-voltage isolation transformer, comprising:
a magnetic core,
a low-voltage winding wound around the magnetic core, wherein the low-voltage winding is exposed in air; and
a medium-voltage winding assembly comprising:
a medium-voltage winding wound around the magnetic core; and
a potting material body, wherein the medium-voltage winding is embedded inside the potting material body, the potting material body is filled with potting material, and the medium-voltage winding is configured by a litz wire whose external surface is covered by a first semi-conductive layer.

2. The medium-voltage isolation transformer according to claim 1, wherein the potting material body is provided with a duct, and terminals of the medium-voltage winding come out from the duct of the potting material body.

3. The medium-voltage isolation transformer according to claim 2, wherein the duct is provided with a top opening and comprises a plurality of fin structure disposed outside the duct.

4. The medium-voltage isolation transformer according to claim 3, wherein the plurality of fin structure is larger near the low-voltage winding than other sides.

5. The medium-voltage isolation transformer according to claim 3, wherein the fin structure near the medium-voltage winding comprises a cover structure partially covering the medium-voltage winding.

6. The medium-voltage isolation transformer according to claim 1, wherein the first semi-conductive layer comprises at least one of a semi-conductive heat shrink tube covering the litz wire or a semi-conductive tape wrapped around the litz wire.

7. The medium-voltage isolation transformer according to claim 1, further comprising a second semi-conductive layer applied to an external surface of the potting material body.

8. The medium-voltage isolation transformer according to claim 1, wherein the potting material body further comprises two bushing structures for the magnetic core to pass through and separating the magnetic core from the medium-voltage winding.

9. The medium-voltage isolation transformer according to claim 8, further comprising a connection cable connected between the second semi-conductive layer and an end of the low-voltage winding.

10. The medium-voltage isolation transformer according to claim 8, further comprising a connection cable connected between the second semi-conductive layer and a direct current output of a low-voltage circuit for the low-voltage winding.

11. The medium-voltage isolation transformer according to claim 1, wherein the first semi-conductive layer is electrically connected to conductors of two ends of the litz wire.
